(19) United States
(12) Patent Application Publication
(10) Pub. No.: US 2024/0228766 A1
(43) Pub. Date: Jul. 11, 2024

(54) POLYMER BLENDS OF POLYVINYL BUTYRAL, STYRENE BLOCK COPOLYMER, AND COMPATIBILIZER

(71) Applicant: Avient Corporation, Avon Lake, OH (US)

(72) Inventor: Liang XU, Vernon Hills, IL (US)

(73) Assignee: Avient Corporation, Avon Lake, OH (US)

(21) Appl. No.: 18/290,243

(22) PCT Filed: May 12, 2022
(86) PCT No.: PCT/US2022/028988

§ 371 Date: Nov. 10, 2023

Related U.S. Application Data
(60) Provisional application No. 63/188,566, filed on May 14, 2021.

(51) Int. Cl. C08L 53/02; C08L 29/14

(52) U.S. Cl. CPC C08L 53/025; C08L 29/14; C08K 2201/009; C08K 2201/019; C08L 2205/03; C08L 2205/08; C08L 2207/20

(57) ABSTRACT

Embodiments of the present disclosure are directed to polymer blends comprising 20 wt % to 45 wt % of polyvinyl butyral (PVB), wherein the PVB comprises virgin PVB, recycled PVB, or combinations thereof; 1 wt % to 35 wt % of styrene block copolymer (SBC); and 5 wt % to 40 wt % of compatibilizer, the compatibilizer comprising a polar copolymer.

### CLAIM OF PRIORITY

This application claims the benefit of U.S. Provisional Patent Application Ser. No. 63/188,566 bearing Attorney Docket Number 1202103 and filed on May 14, 2021, which is hereby incorporated by reference in its entirety.

### TECHNICAL FIELD

Embodiments of the present disclosure are generally related to polymer blends, and are specifically related to polymer blends of polyvinyl butyral, styrene block copolymer, and a compatibilizer having improved compatibility and a maintained or reduced hardness.

### BACKGROUND

Polyvinyl butyral (PVB) is widely used in adhesive and coating applications, such as automotive windshields and solar panels. In the last two decades, technologies were developed to recover PVBs from used automotive windshields and solar panels. These recycled PVBs can be used as a source of post-consumer recycle (PCR) raw material. Blending PVB with a styrene block copolymer (SBC) can create thermoplastic elastomers (TPEs). Due to relatively low cost, softness, elastomer surface feel and processability, such TPEs can be used in many current SBC applications, such as soft grips for consumer products. However, a simple blend of SBC and PVB may not be compatible, particularly as the amount of PVB increases (e.g., greater than or equal to 20 wt % of the polymer blend).

Accordingly, a need exists for polymer blends of PVB and SBC that have improved compatibility while providing a maintained or reduced hardness.

### SUMMARY

Embodiments of the present disclosure are directed to polymer blends of PVB, SBC, and a compatibilizer, which have an increased compatibility, as evidenced by improvement on tensile elongation at break, and exhibit a maintained or reduced hardness.

According to one embodiment, a polymer blend is provided. The polymer blend comprises 20 weight percent (wt %) to 45 wt % of polyvinyl butyral (PVB), wherein the PVB comprises virgin PVB, recycled PVB, or combinations thereof, 1 wt % to 35 wt % of styrene block copolymer (SBC), and 5 wt % to 40 wt % of compatibilizer, the compatibilizer comprising a polar copolymer.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of polymer blends, specifically polymer blends comprising 20 weight percent (wt %) to 45 wt % of polyvinyl butyral (PVB), 1 wt % to 35 wt % of styrene block copolymer (SBC), and 5 wt % to 40 wt % of compatibilizer. The PVB comprises virgin PVB, recycled PVB, or combinations thereof. The compatibilizer comprises a polar copolymer.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The terms “0 wt %,” when used to describe the weight and/or absence of a particular component in a polymer blend means that the component is not intentionally added to the polymer blend. However, the polymer blend may contain traces of the component as a contaminant or tramp in amounts less than 0.05 wt %.

The term “wt %,” as described herein, refers to wt % based on the weight of the polymer blend, unless otherwise noted.

The term “blend,” as described herein, refers to a composition or mixture resulting from melt mixing, or compounding, a neat polymer and at least one other ingredient including but not limited to one or more additives, one or more other polymers, or combinations thereof.

The term “virgin PVB,” as described herein, refers to PVB coming from a source other than a recycled source.

The term “recycled PVB,” as described herein, refers to PVB coming from a recycled source.

The term “pure PVB,” as described herein, refers to PVB present in recycled PVB.

The term “block,” as described herein, refers to a portion of a macromolecule, comprising many constitutional units, that has at least one feature which is not present in the adjacent portions.

The term “polar copolymer,” as described herein, refers to a copolymer having a charge, such as positive or negative.

The term “dynamic viscosity,” as described herein, refers to the resistance to movement of one layer of a fluid over another as measured according to Hoeppler, DIN 53015 at 20° C.

The term “melting point,” as described herein, refers to the temperature at which it changes state from solid to liquid as measured by differential scanning calorimetry (DSC) according to ASTM D3418.

The term “Shore A hardness,” as described herein, refers to the hardness of a material as measured according to ASTM D2240.

The term “Shore D hardness,” as described herein, refers to the hardness of a material as measured according to ASTM D2240.

The term “specific gravity,” as described herein, refers to the ratio of the density of a material to the density of water and is measured according to ASTM D792.

The term “density,” as described herein, refers to the mass per unit volume of a substance as measured according to ASTM D1505.

The term “tensile elongation at break,” as described herein, refers to the ratio between increased length and initial length after breakage as measured according to ASTM D412, Die C.

The term “tensile strength at break,” as described herein, refers to the maximum stress that a material can withstand while stretching before breaking as measured according to ASTM D412, Die C.

The term “glass transition temperature,” as described herein, refers to the temperature where a polymer changes from a rigid glassy material to a soft (not melted) material as determined via differential scanning calorimetry in accordance with ISO 11357-1 (2009).

The term “maintained,” as used herein to describe the Shore A hardness of a material, means that the material has the same Shore A hardness or an insignificantly increased (i.e., less than or equal to 5) Shore A hardness as compared to a conventional thermoplastic elastomer blend including PVB and SBC without a compatibilizer.

As discussed hereinabove, thermoplastic elastomer blends including SBC and PVB have a desired hardness, elastomer surface feel, and processability, which allow for the customized use of these blends in a wide range of applications, such as consumer, healthcare, automotive, packaging, and industrial. However, as the amount of PVB increases (e.g., greater than or equal to 20 wt % of the polymer blend), PVB may not be compatible with SBC. Accordingly, a simple blend of SBC and PVB may not be suitable for producing the polymer blends for these applications.

Disclosed herein are polymer blends which mitigate the aforementioned problems. Specifically, the polymer blends disclosed herein comprise PVB, SBC, and a compatibilizer, which result in a polymer blend having an improved compatibility, as evidenced by an increase in tensile elongation at break as compared to a conventional thermoplastic elastomer blend including PVB and SBC without compatibilizer, and a maintained or reduced hardness. The compatibilizer described herein may be dispersed within at least one of the PVB and the SBC to increase the compatibility of the polymer blend.

The polymer blends disclosed herein may generally be described as comprising the PVB, the SBC, and the compatibilizer. The PVB may comprise virgin PVB, recycled PVB, or combinations thereof. The compatibilizer may comprise a polar copolymer.

### Polyvinyl Butyral

As described hereinabove, the polymer blend comprises polyvinyl butyral (PVB). The PVB may comprise virgin PVB, recycled PVB, or combinations thereof.

In embodiments, the PVB may comprise virgin PVB. In embodiments, the polymer blend may comprise recycled PVB. In embodiments, the polymer blend may comprise both virgin PVB and recycled PVB.

In embodiments, the virgin PVB may have a polyvinyl alcohol content less than or equal to 40 wt %, less than or equal to 35 wt %, less than or equal to 30 wt %, less than or equal to 25 wt %, or even less than or equal to 21 wt %. In embodiments, the virgin PVB may have a polyvinyl alcohol content greater than or equal to 5 wt %, greater than or equal to 10 wt %, greater than or equal to 15 wt %, or even greater than or equal to 18 wt %. In embodiments, the virgin PVB may have a polyvinyl alcohol content from 5 wt % to 40 wt %, from 5 wt % to 35 wt %, from 5 wt % to 30 wt %, from 5 wt % to 25 wt %, from 5 wt % to 21 wt %, from 10 wt % to 40 wt %, from 10 wt % to 35 wt %, from 10 wt % to 30 wt %, from 10 wt % to 25 wt %, from 10 wt % to 21 wt %, from 15 wt % to 40 wt %, from 15 wt % to 35 wt %, from 15 wt % to 30 wt %, from 15 wt % to 25 wt %, from 15 wt % to 21 wt %, from 18 wt % to 40 wt %, from 18 wt % to 35 wt %, from 18 wt % to 30 wt %, from 18 wt % to 25 wt %, or even from 18 wt % to 21 wt %, or any and all sub-ranges formed from any of these endpoints.

In embodiments, the virgin PVB may have a polyvinyl acetate content less than or equal to 6 wt %, less than or equal to 5.5 wt %, less than or equal to 5 wt %, less than or equal to 4.5 wt %, or even less than or equal to 4 wt %. In embodiments, the virgin PVB may have a polyvinyl acetate content greater than or equal to 0.1 wt %, greater than or equal to 0.2 wt %, greater than or equal to 0.5 wt %, or even greater than or equal to 1 wt %. In embodiments, the virgin PVB may have a content from 0.1 wt % to 6 wt %, from 0.1 wt % to 5.5 wt %, from 0.1 wt % to 5 wt %, from 0.1 wt % to 4.5 wt %, from 0.1 wt % to 4 wt %, from 0.2 wt % to 6 wt %, from 0.2 wt % to 5.5 wt %, from 0.2 wt % to 5 wt %, from 0.2 wt % to 4.5 wt %, from 0.2 wt % to 4 wt %, from 0.5 wt % to 6 wt %, from 0.5 wt % to 5.5 wt %, from 0.5 wt % to 5 wt %, from 0.5 wt % to 4.5 wt %, from 0.5 wt % to 4 wt %, from 1 wt % to 6 wt %, from 1 wt % to 5.5 wt %, from 1 wt % to 5 wt %, from 1 wt % to 4.5 wt %, or even from 1 wt % to 4 wt %, or any and all sub-ranges formed from any of these endpoints.

In embodiments, the virgin PVB may have a glass transition temperature less than or equal to 85 Celsius (° C.), less than or equal to 80° C., or even less than or equal to 75° C. In embodiments, the virgin PVB may have a glass transition temperature greater than or equal to 55° C., greater than or equal to 60° C., or even greater than or equal to 65° C. In embodiments, the virgin PVB may have a glass transition temperature from 55° C. to 85° C., from 55° C. to 80° C., from 55° C. to 75° C., from 60° C. to 85° C., from 60° C. to 80° C., from 60° C. to 75° C., from 65° C. to 85° C., from 65° C. to 80° C., or even from 65° C. to 75° C., or any and all sub-ranges formed from any of these endpoints.

In embodiments, the virgin PVB may have a dynamic viscosity of 10 wt % solution in ethanol (containing 5 wt % water) less than or equal to 300 milipascal-second (mPa·s), less than or equal to 280 mPa·s, or even less than or equal to 260 mPa·s. In embodiments, the virgin PVB may have a dynamic viscosity of 10 wt % solution in ethanol (containing 5 wt % water) greater than or equal to 120 mPa·s, greater than or equal to 140 mPa·s, or even greater than or equal to 160 mPa·s. In embodiments, the virgin PVB may have a dynamic viscosity of 10 wt % solution in ethanol (containing 5 wt % water) from 120 mPa·s to 300 mPa·s, from 120 mPa·s to 280 mPa·s, from 120 mPa·s to 260 mPa·s, from 140 mPa·s to 300 mPa·s, from 140 mPa·s to 280 mPa·s, from 140 mPa·s to 260 mPa·s, from 160 mPa·s to 300 mPa·s, from 160 mPa·s to 280 mPa·s, or even from 160 mPa·s to 260 mPa·s, or any and all sub-ranges formed from any of these endpoints.

In embodiments, the virgin PVB may have a dynamic viscosity of 5 wt % solution in n-butanol less than or equal to 90 mPa·s, less than or equal to 85 mPa·s, or even less than or equal to 80 mPa·s. In embodiments, the virgin PVB may have a dynamic viscosity of 5 wt % solution in n-butanol greater than or equal to 35 mPa·s, greater than or equal to 40 mPa·s, or even greater than or equal to 45 mPa·s. In embodiments, the virgin PVB may have a dynamic viscosity of 5 wt % solution in n-butanol from 35 mPa·s to 90 mPa·s, from 35 mPa·s to 85 mPa·s, from 35 mPa·s to 80 mPa·s, from 40 mPa·s to 90 mPa·s, from 40 mPa·s to 85 mPa·s, from 40 mPa·s to 80 mPa·s, from 45 mPa·s to 90 mPa·s, from 45 mPa·s to 85 mPa·s, or even from 45 mPa·s to 80 mPa·s, or any and all sub-ranges formed from any of these endpoints.

Suitable commercial embodiments of the virgin PVB are available under the Mowital brand, such as B 60 H, available from Kuraray.

As discussed hereinabove, the PVB may comprise the recycled PVB. Using the recycled PVB in the polymer blend may provide environmental benefits, as well as reducing costs. However, in embodiments, the recycled PVB may have impurities and color that may result in undesired properties. Accordingly, in embodiments, the recycled PVB may be processed to remove impurities or adjust color prior to being added to the polymer blend.

The recycled PVB may comprise pure PVB and plasticizer. The plasticizer may comprise triethyleneglycol bis (2-ethylhexanoate), dibutyl sebacate, tetraethylene glycol di-n-heptanoate, dihexyl adipate, dioctyl adipate, hexyl adipate, nonyl adipates, hexyl cyclohexyl adipate, phthalates, phthalate esters, or combinations thereof. In embodiments, the recycled PVB may comprise 70 to 100 wt % of the pure PVB and 0 to 30 wt % of the plasticizer. In embodiments, the recycled PVB may include additives.

In embodiments, the amount of the pure PVB in the recycled PVB may be less than or equal to 100 wt %, less than or equal to 95 wt %, or even less than or equal to 90 wt. In embodiments, the amount of the pure PVB in the recycled PVB may be greater than or equal to 70 wt %, greater than or equal to 75 wt %, or even greater than or equal to 80 wt %. In embodiments, the amount of the pure PVB in the recycled PVB may be from 70 wt % to 100 wt %, from 70 wt % to 95 wt %, from 70 wt % to 90 wt %, from 75 wt % to 100 wt %, from 75 wt % to 95 wt %, from 75 wt % to 90 wt %, from 80 wt % to 100 wt %, from 80 wt % to 95 wt %, or even from 80 wt % to 90 wt %, or any and all sub-ranges formed from any of these endpoints.

In embodiments, the amount of plasticizer in the recycled PVB may be less than or equal to 30 wt %, less than or equal to 25 wt %, or even less than or equal to 20 wt %. In embodiments, the amount of plasticizer in the recycled PVB may be greater than or equal to 0 wt %, greater than or equal to 5 wt %, or even greater than or equal to 10 wt %. In embodiments, the amount of plasticizer in the recycled PVB from 0 wt % to 30 wt %, from 0 wt % to 25 wt %, from 0 wt % to 20 wt %, from 5 wt % to 30 wt %, from 5 wt % to 25 wt %, from 5 wt % to 20 wt %, from 10 wt % to 30 wt %, from 10 wt % to 25 wt %, or even from 10 wt % to 20 wt %, or any and all sub-ranges formed from any of these endpoints.

In embodiments, the recycled PVB may have a Shore A hardness less than or equal to 90, less than or equal to 85, less than or equal to 80, less than or equal to 75, or even less than or equal to 70. In embodiments, the recycled PVB may have a Shore A hardness greater than or equal to 45, greater than or equal to 50, greater than or equal to 55, greater than or equal to 60, or even greater than or equal to 65. In embodiments, the recycled PVB may have a Shore A hardness from 45 to 90, from 45 to 85, from 45 to 80, from 45 to 75, from 45 to 70, from 50 to 90, from 50 to 85, from 50 to 80, from 50 to 75, from 50 to 70, from 55 to 90, from 55 to 85, from 55 to 80, from 55 to 75, from 55 to 70, from 60 to 90, from 60 to 85, from 60 to 80, from 60 to 75, from 60 to 70, from 65 to 90, from 65 to 85, from 65 to 80, from 65 to 75, or even from 65 to 70, or any and all sub-ranges formed from any of these endpoints.

In embodiments, the recycled PVB may have a tensile strength at break greater than or equal to 0.345 megapascal (MPa) (50 pounds per square inch (psi)), greater than or equal to 6.895 MPa (1000 psi), or even greater than or equal to 13.790 MPa (2000 psi). In embodiments, the recycled PVB may have a tensile strength at break less than or equal to 34.474 MPa (5000 psi), less than or equal to 27.579 MPa (4000 psi), or even less than or equal to 20.684 MPa (3000 psi). In embodiments, the recycled PVB may have a tensile strength at break from 0.345 MPa (50 psi) to 34.474 MPa (5000 psi), from 0.345 MPa (50 psi) to 27.579 MPa (4000 psi), from 0.345 MPa (50 psi) to 20.684 MPa (3000 psi), from 6.895 MPa (1000 psi) to 34.474 MPa (5000 psi), from 6.895 MPa (1000 psi) to 27.579 MPa (4000 psi), from 6.895 MPa (1000 psi) to 20.684 MPa (3000 psi), from 13.790 MPa (2000 psi) to 34.474 MPa (5000 psi), from 13.790 MPa (2000 psi) to 27.579 MPa (4000 psi), or even from 13.790 MPa (2000 psi) to 20.684 MPa (3000 psi), or any and all sub-ranges formed from any of these endpoints.

In embodiments, the recycled PVB may have a tensile elongation at break greater than or equal to 10%, greater than or equal to 50%, or even greater than or equal to 100%. In embodiments, the recycled PVB may have a tensile elongation at break less than or equal to 500%, less than or equal to 300%, or even less than or equal to 200%. In embodiments, the recycled PVB may have a tensile elongation at break from 10% to 500%, from 10% to 300%, from 10% to 200%, from 50% to 500%, from 50% to 300%, from 50% to 200%, from 100% to 500%, from 100% to 300%, or even from 100% to 200%, or any and all sub-ranges formed from any of these endpoints.

In embodiments, the recycled PVB may have a specific gravity greater than or equal to 0.8, greater than or equal to 0.9, or even greater than or equal to 1.0. In embodiments, the recycled PVB may have a specific gravity less than or equal to 1.5, less than or equal to 1.3, or even less than or equal to 1.2. In embodiments, the recycled PVB may have a specific gravity from 0.8 to 1.5, from 0.8 to 1.3, from 0.8 to 1.2, from 0.9 to 1.5, from 0.9 to 1.3, from 0.9 to 1.2, from 1.0 to 1.5, from 1.0 to 1.3, or even from 1.0 to 1.2, or any and all sub-ranges formed from any of these endpoints.

Suitable commercial embodiments of the recycled PVB are available under the Shark Pellets brand, such as C2c, C4c, available from Shark Solutions.

In embodiments, the amount of the PVB in the polymer blend may be less than or equal to 45 wt %, less than or equal to 43 wt %, less than or equal to 41 wt %, or even less than or equal to 39 wt %. In embodiments, the amount of the PVB in the polymer blend may be greater than or equal to 20 wt %, greater than or equal to 21.7 wt %, greater than or equal to 23 wt %, greater than or equal to 25 wt %, greater than or equal to 27 wt %, or even greater than or equal to 29 wt %. In embodiments, the amount of the PVB in the polymer blend may be from 20 wt % to 45 wt %, from 20 wt % to 43 wt %, from 20 wt % to 41 wt %, from 20 wt % to 39 wt %, from 21.7 wt % to 45 wt %, from 21.7 wt % to 43 wt %, from 21.7 wt % to 41 wt %, from 21.7 wt % to 39 wt %, from 23 wt % to 45 wt %, from 23 wt % to 43 wt %, from 23 wt % to 41 wt %, from 23 wt % to 39 wt %, from 25 wt % to 45 wt %, from 25 wt % to 43 wt %, from 25 wt % to 41 wt %, from 25 wt % to 39 wt %, from 27 wt % to 45 wt %, from 27 wt % to 43 wt %, from 27 wt % to 41 wt %, from 27 wt % to 39 wt %, from 29 wt % to 45 wt %, from 29 wt % to 43 wt %, from 29 wt % to 41 wt %, or even from 29 wt % to 39 wt %, or any and all sub-ranges formed from any of these endpoints.

In embodiments, the amount of the virgin PVB in the polymer blend may be less than or equal to 45 wt %, less than or equal to 43 wt %, less than or equal to 41 wt %, or even less than or equal to 39 wt %. In embodiments, the amount of the virgin PVB in the polymer blend may be greater than or equal to 20 wt %, greater than or equal to 21.7 wt %, greater than or equal to 23 wt %, greater than or equal to 25 wt %, greater than or equal to 27 wt %, or even greater than or equal to 29 wt %. In embodiments, the amount of the virgin PVB in the polymer blend may be from 20 wt % to 45 wt %, from 20 wt % to 43 wt %, from 20 wt % to 41 wt %, from 20 wt % to 39 wt %, from 21.7 wt % to 45 wt %, from 21.7 wt % to 43 wt %, from 21.7 wt % to 41 wt %, from 21.7 wt % to 39 wt %, from 23 wt % to 45 wt %, from 23 wt % to 43 wt %, from 23 wt % to 41 wt %, from 23 wt % to 39 wt %, from 25 wt % to 45 wt %, from 25 wt % to 43 wt %, from 25 wt % to 41 wt %, from 25 wt % to 39 wt %, from 27 wt % to 45 wt %, from 27 wt % to 43 wt %, from 27 wt % to 41 wt %, from 27 wt % to 39 wt %, from 29 wt % to 45 wt %, from 29 wt % to 43 wt %, from 29 wt % to 41 wt %, or even from 29 wt % to 39 wt %, or any and all sub-ranges formed from any of these endpoints.

In embodiments, the amount of the recycled PVB in the polymer blend may be less than or equal to 45 wt %, less than or equal to 43 wt %, less than or equal to 41 wt %, or even less than or equal to 39 wt %. In embodiments, the amount of the recycled PVB in the polymer blend may be greater than or equal to 20 wt %, greater than or equal to 21.7 wt %, greater than or equal to 23 wt %, greater than or equal to 25 wt %, greater than or equal to 27 wt %, or even greater than or equal to 29 wt %. In embodiments, the amount of the recycled PVB in the polymer blend may be from 20 wt % to 45 wt %, from 20 wt % to 43 wt %, from 20 wt % to 41 wt %, from 20 wt % to 39 wt %, from 21.7 wt % to 45 wt %, from 21.7 wt % to 43 wt %, from 21.7 wt % to 41 wt %, from 21.7 wt % to 39 wt %, from 23 wt % to 45 wt %, from 23 wt % to 43 wt %, from 23 wt % to 41 wt %, from 23 wt % to 39 wt %, from 25 wt % to 45 wt %, from 25 wt % to 43 wt %, from 25 wt % to 41 wt %, from 25 wt % to 39 wt %, from 27 wt % to 45 wt %, from 27 wt % to 43 wt %, from 27 wt % to 41 wt %, from 27 wt % to 39 wt %, from 29 wt % to 45 wt %, from 29 wt % to 43 wt %, from 29 wt % to 41 wt %, or even from 29 wt % to 39 wt %, or any and all sub-ranges formed from any of these endpoints.

### Styrene Block Copolymer

As described hereinabove, the polymer blend comprises styrene block copolymer (SBC). Various SBCs are considered suitable for the present polymer blends.

In embodiments, the SBC may comprise a styrene-ethylene/butylene-styrene block copolymer (SEBS), a styrene-(ethylene/propylene)-styrene block copolymer (SEPS), a styrene isoprene block copolymer (SIS), a styrene-isobutylene-styrene block copolymer (SIBS), a styrene-ethylene-ethylene/propylene-styrene block copolymer (SEEPS), a styrene butadiene block copolymer (SBS), or combinations thereof. For example, in embodiments, the styrene copolymer may comprise a SEBS and a SEEPS, a SEBS and a SIS, a SEBS and a SIBS, a SEEPS and a SIS, a SEEPS and a SIBS, or even a SIS and a SIBS. In embodiments, the SBC may comprise a SEBS.

In embodiments, the SBC may have a styrene content less than or equal to 55 wt %, less than or equal to 50 wt %, less than or equal to 45 wt %, less than or equal to 40 wt %, or even less than or equal to 35 wt %. In embodiments, the SBC may have a styrene content greater than or equal to 15 wt %, greater than or equal to 20 wt %, greater than or equal to 25 wt %, or even greater than or equal to 30 wt %. In embodiments, the SBC may have a styrene content from 15 wt % to 55 wt %, from 15 wt % to 50 wt %, from 15 wt % to 45 wt %, from 15 wt % to 40 wt %, from 15 wt % to 35 wt %, from 20 wt % to 55 wt %, from 20 wt % to 50 wt %, from 20 wt % to 45 wt %, from 20 wt % to 40 wt %, from 20 wt % to 35 wt %, from 25 wt % to 55 wt %, from 25 wt % to 50 wt %, from 25 wt % to 45 wt %, from 25 wt % to 40 wt %, from 25 wt % to 35 wt %, from 30 wt % to 55 wt %, from 30 wt % to 50 wt %, from 30 wt % to 45 wt %, from 30 wt % to 40 wt %, or even from 30 wt % to 35 wt %, or any and all sub-ranges formed from any of these endpoints.

In embodiments, the SBC may have a specific gravity greater than or equal to 0.8, or even greater than or equal to 0.9. In embodiments, the SBC may have a specific gravity less than or equal to 1.2, less than or equal to 1.1, or even less than or equal to 1.0. In embodiments, the SBC may have a specific gravity from 0.8 to 1.2, from 0.8 to 1.1, from 0.8 to 1.0, from 0.9 to 1.2, from 0.9 to 1.1, or even from 0.9 to 1.0, or any and all sub-ranges formed from any of these endpoints.

In embodiments, the SBC may have a solution viscosity of 5 wt % toluene solution at 30° C. less than or equal to 55 mPa·s, less than or equal to 50 mPa·s, or even less than or equal to 45 mPa·s. In embodiments, the SBC may have a solution viscosity of 5 wt % toluene solution at 30° C. greater than or equal to 30 mPa·s, greater than or equal to 35 mPa·s, or even greater than or equal to 40 mPa·s. In embodiments, the SBC may have a solution viscosity of 5 wt % toluene solution at 30° C. from 30 mPa·s to 55 mPa·s, from 30 mPa·s to 50 mPa·s, from 30 mPa·s to 45 mPa·s, from 35 mPa·s to 55 mPa·s, from 35 mPa·s to 50 mPa·s, from 35 mPa·s to 45 mPa·s, from 40 mPa·s to 55 mPa·s, from 40 mPa·s to 50 mPa·s, or even from 40 mPa·s to 45 mPa·s, or any and all sub-ranges formed from any of these endpoints.

Suitable commercial embodiments of the SEBS are available under the KRATON brand, available from Kraton Polymers, or under the SEPTON brand, available from Kuraray.

Suitable commercial embodiments of the SEEPS are available under the SEPTON brand, available from Kuraray.

In embodiments, the amount of SBC in the polymer blend may be less than or equal to 35 wt %, less than or equal to 30 wt %, less than or equal to 25 wt %, or even less than or equal to 20 wt %. In embodiments, the amount of SBC in the polymer blend may be greater than or equal to 1 wt %, greater than or equal to 5 wt %, greater than or equal to 7 wt %, greater than or equal to 9 wt %, or even greater than or equal to 11 wt %. In embodiments, the amount of SBC in the polymer blend may be from 1 wt % to 35 wt %, from 1 wt % to 30 wt %, from 1 wt % to 25 wt %, from 1 wt % to 20 wt %, from 5 wt % to 35 wt %, from 5 wt % to 30 wt %, from 5 wt % to 25 wt %, from 5 wt % to 20 wt %, from 7 wt % to 35 wt %, from 7 wt % to 30 wt %, from 7 wt % to 25 wt %, from 7 wt % to 20 wt %, from 9 wt % to 35 wt %, from 9 wt % to 30 wt %, from 9 wt % to 25 wt %, from 9 wt % to 20 wt %, from 11 wt % to 35 wt %, from 11 wt % to 30 wt %, from 11 wt % to 25 wt %, or even from 11 wt % to 20 wt %, or any and all sub-ranges formed from any of these endpoints.

### Compatibilizer

As described hereinabove, the compatibilizer imparts a desired compatibility between PVC and SBC as evidenced by improvement of the tensile elongation at break of the polymer blend. The improved compatibility between PVC and SBC imparts a maintained or reduced hardness (i.e., desired softness), and tensile elongation at break to the polymer blend required for a wide range of applications, such as consumer, healthcare, automotive, packaging, and industrial. The compatibilizer may come from a recycled source.

Various compatibilizers are considered suitable for the present polymer blends. In embodiments, the compatibilizer may comprise a polar copolymer.

In embodiments, the compatibilizer may comprise ethylene alkyl acrylate copolymer, propylene alkyl acrylate copolymer, or combinations thereof. In embodiments, the compatibilizer may comprise ethylene alkyl acrylate copolymer. In embodiments, the compatibilizer may comprise propylene alkyl acrylate copolymer. In embodiments, the compatibilizer may comprise both ethylene alkyl acrylate copolymer and propylene alkyl acrylate copolymer. In embodiments, the ethylene alkyl acrylate copolymer may comprise ethylene methyl acrylate copolymer, ethylene ethyl acrylate, ethylene butyl acrylate copolymer, or combinations thereof.

In embodiments, the compatibilizer may comprise acrylic acid comonomer, maleic anhydride comonomer, alpha olefin comonomer, or combinations thereof. In embodiments, the alpha olefin comonomer may comprise butene, octene, or combinations thereof. In embodiments, the compatibilizer may comprise acrylic acid comonomer neutralized with metal ion. In embodiments, the metal ion may comprise lithium, sodium, potassium, zinc, calcium, or combinations thereof.

In embodiments, the compatibilizer may have a density greater than or equal to 0.8 gram per cubic centimeter (g/cm³), greater than or equal to 0.85 g/cm³, or even greater than or equal to 0.9 g/cm³. In embodiments, the compatibilizer may have a density less than or equal to 1.2 g/cm³, less than or equal to 1.1 g/cm³, or even less than or equal to 1.0 g/cm³. In embodiments, the compatibilizer may have a density from 0.8 g/cm³ to 1.2 g/cm³, from 0.8 g/cm³ to 1.1 g/cm³, from 0.8 g/cm³ to 1.0 g/cm³, from 0.85 g/cm³ to 1.2 g/cm³, from 0.85 g/cm³ to 1.1 g/cm³, from 0.85 g/cm³ to 1.0 g/cm³, from 0.9 g/cm³ to 1.2 g/cm³, from 0.9 g/cm³ to 1.1 g/cm³, or even from 0.9 g/cm³ to 1.0 g/cm³, or any and all sub-ranges formed from any of these endpoints.

In embodiments, the compatibilizer may have a melting point less than or equal to 100° C., less than or equal to 90° C., or even less than or equal to 80° C. In embodiments, the compatibilizer may have a melting point greater than or equal to 50° C., greater than or equal to 60° C., or even greater than or equal to 70° C. In embodiments, the compatibilizer may have a melting point from 50° C. to 100° C., from 50° C. to 90° C., from 50° C. to 80° C., from 60° C. to 100° C., from 60° C. to 90° C., from 60° C. to 80° C., from 70° C. to 100° C., from 70° C. to 90° C., or even from 70° C. to 80° C., or any and all sub-ranges formed from any of these endpoints.

In embodiments, the compatibilizer may have a Shore D hardness less than or equal to 60, less than or equal to 50, or even less than or equal to 40. In embodiments, the compatibilizer may have a Shore D hardness greater than or equal to 10, greater than or equal to 20, or even greater than or equal to 30. In embodiments, the compatibilizer may have a Shore D hardness from 10 to 60, from 10 to 50, from 10 to 40, from 20 to 60, from 20 to 50, from 20 to 40, from 30 to 60, from 30 to 50, or even from 30 to 40, or any and all sub-ranges formed from any of these endpoints.

Suitable commercial embodiments of the compatibilizer are available under the EMAC brand, such as SP 2260, available from Westlake Chemical.

In embodiments, the amount of compatibilizer in the polymer blend may be less than or equal to 40 wt %, less than or equal to 35 wt %, less than or equal to 30 wt %, less than or equal to 27 wt %, or even less than or equal to 25 wt %. In embodiments, the amount of compatibilizer in the polymer blend may be greater than or equal to 1 wt %, greater than or equal to 2 wt %, greater than or equal to 5 wt %, greater than or equal to 10 wt %, or even greater than or equal to 15 wt %. In embodiments, the amount of compatibilizer in the polymer blend may be from 1 wt % to 40 wt %, from 1 wt % to 35 wt %, from 1 wt % to 30 wt %, from 1 wt % to 27 wt %, from 1 wt % to 25 wt %, from 2 wt % to 40 wt %, from 2 wt % to 35 wt %, from 2 wt % to 30 wt %, from 2 wt % to 27 wt %, from 2 wt % to 25 wt %, from 5 wt % to 40 wt %, from 5 wt % to 35 wt %, from 5 wt % to 30 wt %, from 5 wt % to 27 wt %, from 5 wt % to 25 wt %, from 10 wt % to 40 wt %, from 10 wt % to 35 wt %, from 10 wt % to 30 wt %, from 10 wt % to 27 wt %, from 10 wt % to 25 wt %, from 15 wt % to 40 wt %, from 15 wt % to 35 wt %, from 15 wt % to 30 wt %, from 15 wt % to 27 wt %, or even from 15 wt % to 25 wt %, or any and all sub-ranges formed from any of these endpoints.

### Polymer Blend

As described herein, the polymer blends comprise the PVB, the SBC, and the compatibilizer. While not wishing to be bound by theory, it is believed that the increased compatibility achieved by the polymer blends disclosed herein is due to the inclusion of the compatibilizer. The increased tensile elongation at break of the polymer blend, as compared to a blend of PVB and SBC without compatibilizer, indicates an improvement in the compatibility between PVB and the SBC. The polymer blends disclosed herein have may meet the requirements of increased compatibility and a maintained or reduced hardness required for the intended applications.

In embodiments, the polymer blend may comprise a total amount of PVB, SBC, and compatibilizer (i.e., PVB (wt %)+SBC (wt %)+compatibilizer (wt %)) less than or equal to 99 wt %, less than or equal to 95 wt %, or even less than or equal to 90 wt %. In embodiments, the polymer blend may comprise a total amount of PVB, SBC, and compatibilizer greater than or equal to 70 wt %, greater than or equal to 75 wt %, or even greater than or equal to 80 wt %. In embodiments, the total amount of PVB, SBC, and compatibilizer in the polymer blend may be from 70 wt % to 99 wt %, from 70 wt % to 95 wt %, from 70 wt % to 90 wt %, from 75 wt % to 99 wt %, from 75 wt % to 95 wt %, from 75 wt % to 90 wt %, from 80 wt % to 99 wt %, from 80 wt % to 95 wt %, or even from 80 wt % to 90 wt %, or any and all sub-ranges formed from any of these endpoints.

In embodiments, the polymer blend does not include a softener, such as paraffin-type, naphthene-type, or aromatic-type process oils.

The compatibilizer increases the compatibility of the polymer blend as evidenced by increased tensile elongation at break of the polymer blend. In embodiments, the polymer blend may have a tensile elongation at break greater than or equal to 10%, greater than or equal to 15%, or even greater than or equal to 20%. In embodiments, the polymer blend may have a tensile elongation at break less than or equal to 1000%, less than or equal to 900%, or even less than or equal to 800%. In embodiments, the polymer blend may have a tensile elongation at break from 10% to 1000%, from 10% to 900%, from 10% to 800%, from 15% to 1000%, from 15% to 900%, from 15% to 800%, from 20% to 1000%, from 20% to 900%, or even from 20% to 800%, or any and all sub-ranges formed from any of these endpoints.

In embodiments, the polymer blend may have a maintained or reduced hardness (i.e., desired softness) for the intended applications. In embodiments, the polymer blend may have a Shore A hardness less than or equal to 100, less than or equal to 95, or even less than or equal to 90. In embodiments, the polymer blend may have a Shore A hardness greater than or equal to 5, greater than or equal to 10, greater than or equal to 15, greater than or equal to 20, or even greater than or equal to 25. In embodiments, the polymer blend may have a Shore A hardness from 5 to 100, from 5 to 95, from 5 to 90, from 10 to 100, from 10 to 95, from 10 to 90, from 15 to 100, from 15 to 95, from 15 to 90, from 20 to 100, from 20 to 95, from 20 to 90, from 25 to 100, from 25 to 95, or even from 25 to 90, or any and all sub-ranges formed from any of these endpoints.

In embodiments, the polymer blend may have a tensile strength at break greater than or equal to 0.345 megapascal (MPa) (50 pounds per square inch (psi)), greater than or equal to 0.689 MPa (100 psi), or even greater than or equal to 1.034 MPa (150 psi). In embodiments, the polymer blend may have a tensile strength at break less than or equal to 8.963 MPa (1300 psi), less than or equal to 8.274 MPa (1200 psi), or even less than or equal to 6.895 MPa (1000 psi). In embodiments, the polymer blend may have a tensile strength at break from 0.345 MPa (50 psi) to 8.963 MPa (1300 psi), from 0.345 MPa (50 psi) to 8.274 MPa (1200 psi), from 0.345 MPa (50 psi) to 6.895 MPa (1000 psi), from 0.689 MPa (100 psi) to 8.963 MPa (1300 psi), from 0.689 MPa (100 psi) to 8.274 MPa (1200 psi), from 0.689 MPa (100 psi) to 6.895 MPa (1000 psi), from 1.034 MPa (150 psi) to 8.963 MPa (1300 psi), from 1.034 MPa (150 psi) to 8.274 MPa (1200 psi), or even from 1.034 MPa (150 psi) to 6.895 MPa (1000 psi), or any and all sub-ranges formed from any of these endpoints.

In embodiments, the polymer blend may be used to form a thermoplastic elastomer (TPE), a thermoplastic vulcanizate (TPV), or a thermoset elastomer.

### Plasticizer

In embodiments, the polymer blend may further comprise a plasticizer. The plasticizer may be used, for example, to adjust the hardness and/or improve flow or other properties of the polymer blend. In embodiments, the plasticizer may comprise mineral oil, vegetable oil, synthetic oil, or combinations thereof.

In embodiments, the amount of plasticizer in the polymer blend may be less than or equal to 40 wt %, less than or equal to 35 wt %, less than or equal to 30 wt %, less than or equal to 25 wt %, or even less than or equal to 20 wt %. In embodiments, the amount of plasticizer in the polymer blend may be greater than or equal to 0 wt %, greater than or equal to 1 wt %, greater than or equal to 5 wt %, or even greater than or equal to 10 wt %. In embodiments, the amount of the plasticizer in the polymer blend may be from 0 wt % to 40 wt %, from 0 wt % to 35 wt %, from 0 wt % to 30 wt %, from 0 wt % to 25 wt %, from 0 wt % to 20 wt %, from 1 wt % to 40 wt %, from 1 wt % to 35 wt %, from 1 wt % to 30 wt %, from 1 wt % to 25 wt %, from 1 wt % to 20 wt %, from 5 wt % to 40 wt %, from 5 wt % to 35 wt %, from 5 wt % to 30 wt %, from 5 wt % to 25 wt %, from 5 wt % to 20 wt %, from 10 wt % to 40 wt %, from 10 wt % to 35 wt %, from 10 wt % to 30 wt %, from 10 wt % to 25 wt %, or even from 10 wt % to 20 wt %, or any and all sub-ranges formed from any of these endpoints.

Suitable commercial embodiments of the plasticizer are available under the PURETOL 380 brand from Petro-Canada, and those available under the PRIMOL 382 brand from ExxonMobil.

### Antioxidant

In embodiments, the polymer blend may further comprise the antioxidant. In embodiments, the amount of antioxidant in the polymer blend may be less than or equal to 5 wt %, less than or equal to 4 wt %, less than or equal to 3 wt %, less than or equal to 2 wt %, or even less than or equal to 1 wt %. In embodiments, the amount of antioxidant in the polymer blend may be greater than or equal to 0 wt %, greater than or equal to 0.001 wt %, or even greater than or equal to 0.01 wt %. In embodiments, the amount of antioxidant in the polymer blend may be from 0 wt % to 5 wt %, from 0 wt % to 4 wt %, from 0 wt % to 3 wt %, from 0 wt % to 2 wt %, from 0 wt % to 1 wt %, from 0.001 wt % to 5 wt %, from 0.001 wt % to 4 wt %, from 0.001 wt % to 3 wt %, from 0.001 wt % to 2 wt %, from 0.001 wt % to 1 wt %, from 0.01 wt % to 5 wt %, from 0.01 wt % to 4 wt %, from 0.01 wt % to 3 wt %, from 0.01 wt % to 2 wt %, or even from 0.01 wt % to 1 wt %, or any and all sub-ranges formed from any of these endpoints.

Suitable commercial embodiments of antioxidant are available under the IRGAFOS or IRGANOX brand, available from BASF.

### Additives

In embodiments, the polymer blend may further comprise an additive. The additive can be used in any amount that is sufficient to obtain a desired processing or performance property for the polymer blend. The amount should not be wasteful of the additive nor detrimental to the processing or performance of the polymer blend.

In embodiments, the additive may comprise glass beads; anti-blocking agents; stabilizers; adhesion promoters; anti-fogging agents; anti-static agents; biocides (antibacterials, fungicides, and mildewcides); colorants including pigments and dyes; dispersants; fillers and extenders; fire and flame retardants and smoke suppressants; hardness adjusters; impact modifiers; initiators; lubricants; micas; mold release agents; processing aids; silanes, titanates and zirconates; stearates; ultraviolet light absorbers; viscosity regulators; or combinations thereof.

In embodiments, the amount of additive in the polymer blend may be less than or equal to 5 wt %, less than or equal to 4 wt %, less than or equal to 3 wt %, less than or equal to 2 wt %, or even less than or equal to 1 wt %. In embodiments, the amount of additive in the polymer blend may be greater than or equal to 0 wt %, greater than or equal to 0.001 wt %, or even greater than or equal to 0.01 wt %. In embodiments, the amount of additive in the polymer blend may be from 0 wt % to 5 wt %, from 0 wt % to 4 wt %, from 0 wt % to 3 wt %, from 0 wt % to 2 wt %, from 0 wt % to 1 wt %, from 0.001 wt % to 5 wt %, from 0.001 wt % to 4 wt %, from 0.001 wt % to 3 wt %, from 0.001 wt % to 2 wt %, from 0.001 wt % to 1 wt %, from 0.01 wt % to 5 wt %, from 0.01 wt % to 4 wt %, from 0.01 wt % to 3 wt %, from 0.01 wt % to 2 wt %, or even from 0.01 wt % to 1 wt %, or any and all sub-ranges formed from any of these endpoints.

### Processing

In embodiments, the polymer blend described herein may be made with batch process or continuous process.

In embodiments, the components of the polymer blend may be added all together in an extruder and mixed. In embodiments, mixing may be a continuous process at an elevated temperature (e.g., 120° C.-250° C.) with a mixing speed of from 200 revolution per minute (rpm) to 700 rpm that is sufficient to melt the polymer matrix. In embodiments, fillers may be added at the feed-throat, or by injection or side-feeders downstream. In embodiments, the output from the extruder is pelletized for later extrusion, molding, thermoforming, foaming, calendaring, and/or other processing into polymeric articles.

### Applications

As described herein, the polymer blends can be useful for making any type of product, for which properties such as a maintained or reduced hardness and increased tensile elongation at break are desirable or required.

The polymer blends have potential for use in applications in many different industries, including but not limited to: automotive and transportation; consumer products; electronics; healthcare and medical; household appliances; packaging; and other industries or applications benefiting from the unique combination of properties.

In embodiments, the polymer blends can be especially useful for making a soft grip for a consumer product, such as a razor handle.

### EXAMPLES

Table 1 shows sources of ingredients for the polymer blends of Examples 1-8 and Comparative Examples C1-C10.

TABLE 1

| Ingredient | Brand | Source |
|---|---|---|
| PVB | Mowital B 60 H | Kuraray |
| Recycled PVB | Shark Pellets C2c | Shark solutions |
| SEBS | Septon 8006 | Kuraray |
| Polyethylene | EMAC SP 2260 | Westlake Chemical |
| methyl acrylate | | |
| copolymer | | |
| Mineral oil | Puretol PSO 380 | Petro Canada |
| Antioxidant | Irgafos 168 | BASF |
| Antioxidant | Irganox 1010 | BASF |
| Additive | Kemamide E ultra | PMC Biogenix |

### Examples 1-8

Table 2 shows the formulations (in parts and wt %) and certain properties (Shore A Hardness, Specific Gravity, Tensile strength, Elongation at Break, and Viscosity) of Examples 1-8.

TABLE 2

| | Examples | | | | | |
|---|---|---|---|---|---|---|
| | 1 | | 2 | | 3 | |
| | parts | wt % | parts | wt % | parts | wt % |
| Septon 8006 | 100 | 25.81 | 100 | 19.14 | 100 | 15.21 |
| Puretol PSO 380 | 150 | 38.72 | 150 | 28.71 | 150 | 22.82 |
| EMAC SP2260 | 50 | 12.91 | 100 | 19.14 | 150 | 22.82 |
| Mowital B 60H | 85 | 21.94 | 170 | 32.54 | 255 | 38.79 |
| Shark Pellets C2c | 0 | 0 | 0 | 0 | 0 | 0 |
| Irgafos 168 | 0.8 | 0.21 | 0.8 | 0.15 | 0.8 | 0.12 |
| Irganox 1010 | 0.8 | 0.21 | 0.8 | 0.15 | 0.8 | 0.12 |
| Kemamide E | 0.8 | 0.21 | 0.8 | 0.15 | 0.8 | 0.12 |
| Total | 387.4 | 100 | 522.4 | 100 | 657.4 | 100 |
| Hardness, A | 49 | | 67 | | 87 | |
| Specific Gravity | 0.93 | | 0.95 | | 0.97 | |
| Tensile Strength, MPa | 2.027 (294 psi) | | 3.254 (472 psi) | | 7.329 (1063 psi) | |
| Elongation at break, % | 209 | | 67 | | 38 | |
| Capillary Rheometer | 200 | | 200 | | 200 | |
| test temperature | | | | | | |

| | | | |
|---|---|---|---|
| Viscosity @ 1340.5/sec | 57 | 68 | 80 |

| | Examples | | | |
|---|---|---|---|---|
| | 4 | | 5 | |
| | parts | wt % | parts | wt % |
| Septon 8006 | 100 | 12.62 | 100 | 25.81 |
| Puretol PSO 380 | 150 | 18.93 | 150 | 38.72 |
| EMAC SP2260 | 200 | 25.24 | 50 | 12.91 |
| Mowital B 60H | 340 | 42.91 | 0 | 0 |
| Shark Pellets C2c | 0 | 0 | 85 | 21.94 |
| Irgafos 168 | 0.8 | 0.10 | 0.8 | 0.21 |
| Irganox 1010 | 0.8 | 0.10 | 0.8 | 0.21 |
| Kemamide E | 0.8 | 0.10 | 0.8 | 0.21 |
| Total | 792.4 | 100 | 387.4 | 100 |

| | | |
|---|---|---|
| Hardness, A | 78 | 31 |
| Specific Gravity | 0.98 | 0.92 |
| Tensile Strength, MPa | 3.544 (514 psi) | 1.400 (203 psi) |
| Elongation at break, % | 44 | 522 |
| Capillary Rheometer | 200 | 200 |
| test temperature | | |
| Viscosity @, 1340.5/sec | 110 | 51 |

| | Examples | | | | | |
|---|---|---|---|---|---|---|
| | 6 | | 7 | | 8 | |
| | parts | wt % | parts | wt % | parts | wt % |
| Septon 8006 | 100 | 19.14 | 100 | 15.21 | 100 | 12.62 |
| Puretol PSO 380 | 150 | 28.71 | 150 | 22.82 | 150 | 18.93 |
| EMAC SP2260 | 100 | 19.14 | 150 | 22.82 | 200 | 25.24 |
| Mowital B 60H | 0 | 0 | 0 | 0 | 0 | 0 |
| Shark Pellets C2c | 170 | 32.54 | 255 | 38.79 | 340 | 42.91 |
| Irgafos 168 | 0.8 | 0.15 | 0.8 | 0.12 | 0.8 | 0.10 |
| Irganox 1010 | 0.8 | 0.15 | 0.8 | 0.12 | 0.8 | 0.10 |
| Kemamide E | 0.8 | 0.15 | 0.8 | 0.12 | 0.8 | 0.10 |
| Total | 522.4 | 100 | 657.4 | 100 | 792.4 | 100 |
| Hardness, A | 44 | | 54 | | 61 | |
| Specific Gravity | 0.95 | | 0.96 | | 0.97 | |
| Tensile Strength, MPa | 1.344 (195 psi) | | 1.682 (244 psi) | | 1.924 (279 psi) | |
| Elongation at break, % | 313 | | 298 | | 130 | |
| Capillary Rheometer | 200 | | 200 | | 200 | |
| test temperature | | | | | | |

| | | | |
|---|---|---|---|
| Viscosity @ 1340.5/sec | 53 | 55 | 60 |

### Comparative Examples C1-C10

Table 3 shows the formulations (in parts and wt %) and certain properties (Shore A Hardness, Specific Gravity, Tensile strength, Elongation at Break, and Viscosity) of Comparative Examples C1-C10.

TABLE 3

| | Comparative Examples | | | | | |
|---|---|---|---|---|---|---|
| | C1 | | C2 | | C3 | |
| | parts | wt % | parts | wt % | parts | wt % |
| Septon 8006 | 100 | 29.64 | 100 | 23.67 | 100 | 19.71 |
| Puretol PSO 380 | 150 | 44.46 | 150 | 35.51 | 150 | 29.56 |
| EMAC SP2260 | 0 | 0 | 0 | 0 | 0 | 0 |
| Mowital B 60H | 85 | 25.19 | 170 | 40.25 | 255 | 50.26 |
| Shark Pellets C2c | 0 | 0 | 0 | 0 | 0 | 0 |
| Irgafos 168 | 0.8 | 0.24 | 0.8 | 0.19 | 0.8 | 0.16 |
| Irganox 1010 | 0.8 | 0.24 | 0.8 | 0.19 | 0.8 | 0.16 |
| Kemamide E | 0.8 | 0.24 | 0.8 | 0.19 | 0.8 | 0.16 |
| Total | 337.4 | 100 | 422.4 | 100 | 507.4 | 100 |
| Hardness, A | 53 | | 71 | | 92 | |
| Specific Gravity | 0.92 | | 0.95 | | 0.97 | |
| Tensile Strength, MPa | 2.193 (318 psi) | | 4.847 (703 psi) | | 8.267 (1199 psi) | |
| Elongation at break, % | 67 | | 13 | | 8.6 | |
| Capillary Rheometer | 200 | | 200 | | 200 | |
| test temperature | | | | | | |
| Viscosity @ 1340.5/sec | 71 | | 78 | | 80 | |
| | Comparative Examples | | | | | |
| | C4 | | C5 | | C6 | |
| | parts | wt % | parts | wt % | parts | wt % |
| Septon 8006 | 100 | 16.88 | 100 | 29.64 | 100 | 23.67 |
| Puretol PSO 380 | 150 | 25.32 | 150 | 44.46 | 150 | 35.51 |
| EMAC SP2260 | 0 | 0 | 0 | 0 | 0 | 0 |
| Mowital B 60H | 340 | 57.39 | 0 | 0 | 0 | 0 |
| Shark Pellets C2c | 0 | 0 | 85 | 25.19 | 170 | 40.25 |
| Irgafos 168 | 0.8 | 0.14 | 0.8 | 0.24 | 0.8 | 0.19 |
| Irganox 1010 | 0.8 | 0.14 | 0.8 | 0.24 | 0.8 | 0.19 |
| Kemamide E | 0.8 | 0.14 | 0.8 | 0.24 | 0.8 | 0.19 |
| Total | 592.4 | 100 | 337.4 | 100 | 422.4 | 100 |
| Hardness, A | 96 | | 36 | | 52 | |
| Specific Gravity | 0.98 | | 0.92 | | 0.95 | |
| Tensile Strength, MPa | 11.452 (1661 psi) | | 1.234 (179 psi) | | 2.130 (309 psi) | |
| Elongation at break, % | 5 | | 155 | | 70 | |
| Capillary Rheometer | 200 | | 200 | | 200 | |
| test temperature | | | | | | |
| Viscosity @ 1340.5/sec | 89 | | 66 | | 66 | |
| | Comparative Examples | | | | | |
| | C7 | | C8 | | C9 | |
| | parts | wt % | parts | wt % | parts | wt % |
| Septon 8006 | 100 | 19.71 | 100 | 16.88 | 100 | 13.12 |
| Puretol PSO 380 | 150 | 29.56 | 150 | 25.32 | 150 | 19.67 |
| EMAC SP2260 | 0 | 0 | 0 | 0 | 0 | 0 |
| Mowital B 60H | 0 | 0 | 0 | 0 | 0 | 0 |
| Shark Pellets C2c | 255 | 50.26 | 340 | 57.39 | 510 | 66.89 |
| Irgafos 168 | 0.8 | 0.16 | 0.8 | 0.14 | 0.8 | 0.10 |
| Irganox 1010 | 0.8 | 0.16 | 0.8 | 0.14 | 0.8 | 0.10 |
| Kemamide E | 0.8 | 0.16 | 0.8 | 0.14 | 0.8 | 0.10 |
| Total | 507.4 | 100 | 592.4 | 100 | 762.4 | 100 |
| Hardness, A | 57 | | 58 | | 59 | |
| Specific Gravity | 0.97 | | 0.98 | | 1.00 | |
| Tensile Strength, MPa | 2.558 (371 psi) | | 2.723 (395 psi) | | 2.965 (430 psi) | |
| Elongation at break, % | 36 | | 98 | | 142 | |
| Capillary Rheometer | 200 | | 200 | | 200 | |
| test temperature | | | | | | |

| | | | |
|---|---|---|---|
| Viscosity @ 1340.5/sec | 65 | 61 | 61 |

| | Comparative Examples | |
|---|---|---|
| | C10 | |
| | parts | wt % |
| Septon 8006 | 100 | 9.41 |
| Puretol PSO 380 | 150 | 14.12 |
| EMAC SP2260 | 300 | 28.24 |
| Mowital B 60H | 0 | 0 |
| Shark Pellets C2c | 510 | 48.00 |
| Irgafos 168 | 0.8 | 0.08 |
| Irganox 1010 | 0.8 | 0.08 |
| Kemamide E | 0.8 | 0.08 |
| Total | 1062.4 | 100 |

| | |
|---|---|
| Hardness, A | 69 |
| Specific Gravity | 0.98 |
| Tensile Strength, MPa | 2.951 (428 psi) |
| Elongation at break, % | 102 |
| Capillary Rheometer | 200 |
| test temperature | |
| Viscosity @ 1340.5/sec | 68 |

### Evaluating Compatibility and Hardness

As shown in Tables 2 and 3, Examples 1-4, polymer blends including virgin PVB, a SBC, and a compatibilizer, had an increased tensile elongation at break while having a reduced Shore A hardness as compared to Comparative Examples C1-C4, respectively, polymer blends including virgin PVB and a SBC without a compatibilizer. As indicated by the Examples and Comparative Examples shown in Tables 2 and 3, including a compatibilizer increases compatibility of the polymer blend and the polymer blend has a reduced Shore A hardness (i.e., desired softness) as compared to a mixture of virgin PVB and a SBC without a compatibilizer.

As further shown in Tables 2 and 3, Examples 5-8, polymer blends including recycled PVB, a SBC, and a compatibilizer, had an increased tensile elongation at break while having a reduced or insignificantly increased Shore A hardness as compared to Comparative Example C5-C8, respectively, polymer blends including recycled PVB and a SBC without compatibilizer. As indicated by the Examples and Comparative Examples shown in Tables 2 and 3, including a compatibilizer increases compatibility of the polymer blend and the polymer blend has a maintained or reduced Shore A hardness as compared to a mixture of recycled PVB and a SBC without a compatibilizer.

As further shown in Table 3, Comparative Example C10, a polymer blend including recycled PVB, a SBC, and a compatibilizer, did not have an increased tensile elongation at break as compared to Comparative Example C9, a polymer blend including recycled PVB and a SBC without compatibilizer. Instead, the tensile elongation at break decreased. The recycled PVB was a combination of pure PVB and plasticizer. While not wishing to be bound by theory, it is believed that the plasticizer present in the recycled PVB may have led to a reduced tensile elongation at break as the amount of recycled PVB was increased.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

What is claimed is:

1. A polymer blend comprising:
20 weight percent (wt %) to 45 wt % of polyvinyl butyral (PVB), wherein the PVB comprises virgin PVB, recycled PVB, or combinations thereof;
1 wt % to 35 wt % of styrene block copolymer (SBC); and
5 wt % to 40 wt % of compatibilizer, the compatibilizer comprising a polar copolymer.

2. The polymer blend of claim 1, wherein the SBC comprises a styrene-ethylene/butylene-styrene block copolymer (SEBS), a styrene-(ethylene/propylene)-styrene block copolymer (SEPS), a styrene isoprene block copolymer (SIS), a styrene-isobutylene-styrene block copolymer (SIBS), a styrene-ethylene-ethylene/propylene-styrene block copolymer (SEEPS), a styrene butadiene block copolymer (SBS), or combinations thereof.

3. The polymer blend of claim 1, wherein the SBC comprises the SEBS.

4. The polymer blend of claim 1, wherein the SBC comprises the SEEPS.

5. The polymer blend of claim 1, wherein the compatibilizer comprises ethylene alkyl acrylate copolymer, propylene alkyl acrylate copolymer, or combinations thereof.

6. The polymer blend of claim 5, wherein the compatibilizer comprises the ethylene alkyl acrylate copolymer, the ethylene alkyl acrylate copolymer comprising ethylene methyl acrylate copolymer, ethylene ethyl acrylate, ethylene butyl acrylate copolymer, or combinations thereof.

7. The polymer blend of claim 1, wherein the compatibilizer comprises acrylic acid comonomer, maleic anhydride comonomer, alpha olefin comonomer, or combinations thereof.

8. The polymer blend of claim 7, wherein the compatibilizer comprises the alpha olefin comonomer, the alpha olefin comonomer comprising butene, octene, or combinations thereof.

9. The polymer blend of claim 1, wherein the compatibilizer comprises acrylic acid comonomer neutralized with a metal ion.

10-20. (canceled)

21. The polymer blend of claim 1, wherein the polymer blend comprises:
20 wt % to 45 wt % of the PVB;
5 wt % to 30 wt % of the SBC, the SBC comprising a styrene-ethylene/butylene-styrene block copolymer (SEBS); and
10 wt % to 30 wt % of the compatibilizer, the compatibilizer comprising at least one of ethylene methyl acrylate copolymer and ethylene butyl acrylate copolymer.

22. The polymer blend of claim 1, wherein the polymer blend further comprises 10 wt % to 40 wt % of a mineral oil.

23. The polymer blend of claim 1, wherein the polymer blend further comprises 0.01 wt % to 1 wt % of an antioxidant.

24. The polymer blend of claim 1, wherein the polymer blend further comprises 0.01 wt % to 1 wt % of an additive.

25. The polymer blend of claim 1, wherein the polymer blend has a Shore A Hardness from 25 to 100 as measured according to ASTM D2240.

26. The polymer blend of claim 1, wherein the polymer blend has a tensile elongation at break greater than or equal to 20 percent (%) as measured according to ASTM D412.

27. The polymer blend of claim 1, wherein the polymer blend comprises a total amount of PVB, SBC, and compatibilizer greater than or equal to 70 wt %.

28. The polymer blend of claim 1, wherein the polymer blend does not include a softener.
